(19) United States
(12) Patent Application Publication
(10) Pub. No.: US 2010/0245543 A1
(43) Pub. Date: Sep. 30, 2010

(54) MRI COMPATIBLE CAMERA THAT INCLUDES A LIGHT EMITTING DIODE FOR ILLUMINATING A SITE

(76) Inventors: Alexander Greer, Calgary (CA); Garnette Sutherland, Calgary (CA); Tim Fielding, Brampton (CA); Perry Newhook, Caledon (CA); Simon Yu, Richmond Hill (CA)

Correspondence Address: FULBRIGHT & JAWORSKI L.L.P., 600 CONGRESS AVE., SUITE 2400, AUSTIN, TX, 78701, US

(21) Appl. No.: 12/596,424

(22) PCT Filed: Apr. 16, 2008
(86) PCT No.: PCT/IB2008/003669

§ 371 Date: May 17, 2010

Related U.S. Application Data
(60) Provisional application No. 60/912,148, filed on Apr. 16, 2007.

(51) Int. Cl. H04N 7/18; H04N 13/02

(52) U.S. Cl. 348/46; 348/77; 348/E07.085

(57) ABSTRACT

Systems and methods of using MR-compatible cameras to view magnetic resonance imaging procedures. The MR-compatible camera systems may include a casing with at least two openings, including one oriented to permit a camera to view a site, and another opening oriented to permit a light source to illuminate a portion of the site. The camera systems may be used with either closed bore or open bore MRI systems.

### CROSS REFERENCE TO RELATED APPLICATION

This application claims priority to U.S. Provisional Patent Application Ser. No. 60/912,148, filed Apr. 16, 2007, which is incorporated by reference.

### BACKGROUND INFORMATION

The present methods, devices, and systems relate generally to the field of surgical robotics, and more particularly to cameras systems that can be used during surgical procedures involving a surgical robot and to techniques for illuminating and capturing images of space within an open or closed bore of a magnetic resonance imaging (MRI) system. An example of a surgical robot that can be used in a procedure to which the present methods, devices, and systems relate is disclosed in U.S. Pat. No. 7,155,316 (the '316 patent), which is incorporated by reference.

### SUMMARY

Broadly, the present invention concerns methods and systems for illuminating and/or obtaining images of operating space within an MRI system, including when the MRI system is taking magnetic resonance (MR) images of an object, such as a patient. For example, embodiments of the present camera systems may be used during stereotactic procedures.

Some embodiments of the present camera systems comprise a first magnetic resonance (MR) compatible casing having at least two separate openings; a first camera oriented to view a site through one of the separate openings; and a first light emitting diode (LED) light source oriented to illuminate at least a portion of the site through another of the separate openings.

Some embodiments of the present camera systems are for use with a manipulator configured to be secured to an extension member (e.g., an extension board) that can be coupled to an operating table on which a patient can be positioned for a stereotactic procedure. The manipulator may be operable to move a surgical instrument (or tool) located within the bore of a magnet of an MRI system. Such camera systems may comprise a first magnetic resonance (MR) compatible camera system configured to be coupled to the extension member; and a second MR-compatible camera system configured to be coupled to the extension member.

Some embodiments of the present methods comprise illuminating a space within the bore of a magnet of a magnetic resonance imaging (MRI) system with a light emitting diode (LED) light source coupled to a camera positioned within the bore, the illuminating occurring during a surgical procedure on a patient located at least partially within the bore.

Some embodiments of the present methods may comprise illuminating a first portion of a patient positioned at least partially within a bore of a magnet of a magnetic resonance imaging (MRI) system with a first light emitting diode (LED) light source coupled to a first camera positioned within the bore; and illuminating a second portion of the patient with a second LED light source coupled to a second camera positioned within the bore; where the first and second portions overlap to at least some extent, and the illuminating of both portions occurs at the same time and during a surgical procedure on the patient.

Some embodiments of the present methods may comprise positioning a first LED light source coupled to a first camera in a bore of a magnet of a magnetic resonance imaging (MRI) system; and positioning a second LED light source coupled to a second camera in the bore.

Some embodiments of the present methods may comprise orienting two of the present camera systems at a distance apart from each other and at an angle toward a site to be imaged such that they capture views that can be presented to a user as a three-dimensional stereoscopic image (that, e.g., provides perspective and depth) through a suitable display device, such as a microscope viewer, a microscope binocular tube, stereoscope eyepieces, or a stereoscopic display unit. Such methods may also comprise outputting the 3D stereoscopic image for viewing by a user.

Some embodiments of the present methods may comprise positioning an LED light source coupled to a camera in a bore of a magnet of a magnetic resonance imaging (MRI) system; and supplying power to both the LED light source and the camera while the MRI system images an object.

Any embodiment of any of the present methods, devices, and systems may consist of or consist essentially of—rather than comprise/include/contain/have—the described steps and/or features. Thus, in any of the claims, the term “consisting of” or “consisting essentially of” may be substituted for any of the open-ended linking verbs recited above, in order to change the scope of a given claim from what it would otherwise be using the open-ended linking verb.

### BRIEF DESCRIPTION OF THE FIGURES

The following drawings illustrate by way of example and not limitation. Identical reference numerals do not necessarily indicate an identical structure. Rather, the same reference numeral may be used to indicate a similar feature or a feature with similar functionality. Every feature of each embodiment is not always labeled in every figure in which that embodiment appears, in order to keep the figures clear. The camera system structures shown in the figures (as well as the manipulator and the assembly shown in FIG. 3A) are drawn to scale, meaning the sizes of the depicted elements are accurate relative to each other.

FIG. 1 is a perspective view of one embodiment of the present imaging systems comprising two camera systems mounted on an extension board;

FIG. 2 is a top view of the imaging system embodiment of FIG. 1;

FIG. 3A is a perspective view of the imaging system embodiment of FIG. 1 in an environment where a manipulator is mounted on the extension board;

FIGS. 3B and 3C are views that may be taken with an embodiment of a two-camera system version of the present imaging systems.

FIGS. 4A and 4B are perspective views (FIG. 4B being an enlarged view of a portion of what is shown in FIG. 4A) of the imaging system embodiment of FIG. 1 used in an open bore MRI system;

FIG. 5 is a perspective view of the imaging system embodiment of FIG. 1 used in a closed bore MRI system;

FIG. 6 is an end view of the arrangement shown in FIG. 5;

FIG. 7 is a front perspective view of a camera system of the imaging system embodiment of FIG. 1;

FIG. 8A depicts components of a camera that may be used with embodiments of the present camera systems;

FIG. 8B depicts components of a light source (specifically, an LED light source) that may be used with embodiments of the present camera systems;

FIG. 9A is a back view of the camera system of FIG. 7;

FIG. 9B is a perspective view of the camera system of FIG. 7 that includes a camera (not visible) and an LED light source in the camera system casing, as well as a conduit channeling cables to both the camera and LED light source; and

FIGS. 10 and 11A-11C illustrate a schematic view of an exemplary embodiment of a wiring system for the camera system shown in FIG. 7.

### DETAILED DESCRIPTION OF ILLUSTRATIVE EMBODIMENTS

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

Thus, a method comprising certain steps is a method that includes at least the recited steps, but is not limited to possessing only the recited steps. Similarly, a camera system comprising certain elements or features includes at least those recited, but is not limited to possessing only the recited elements/features. Furthermore, a structure that is configured in a certain way must be configured in at least that way, but also may be configured in a way or ways that are not specified.

The terms “a” and “an” are defined as one or more than one, unless this application expressly requires otherwise. The term “another” is defined as at least a second or more. The terms “substantially” is defined as at least close to (and includes) a given value or state (preferably within 10% of, more preferably within 1% of, and most preferably within 0.1% of).

The inventors have designed camera systems that may be used safely in the bore of an open or closed magnet of an MRI system (also known as open or closed MRI systems). They were guided by trying to ensure safe operation of the camera system while inside the MRI system, as well as safe operation of the MRI system while the camera system is inside the MRI system. They were also guided by trying to ensure that the image(s) their camera systems produce is not significantly degraded by operation of the MR magnet when a scan is taken as the camera system is taking images, nor is the image(s) significantly degraded by the camera system's presence or operation. The camera system and MRI system should be compatible so as to avoid causing unwanted movement of material, heat generation, or electrical transmissions due to magnetic forces.

The inventors' efforts to meet their goals resulted in the design of camera systems having a minimized amount of magnetic material in the camera and in the light source for illuminating the space imaged by the camera, as well as an ability to function in strong magnetic fields, such as 1.5 or 3.0 Tesla superconducting magnets. The inventors took steps to minimize and shield the radio frequency (RF) noise created by the camera and light of their camera systems, so that the noise stays inside of a sealed environment (for example, the housing for the camera and the light and the cable or cables supplying power and/or receiving data from the light and camera). The inventors note that it can also be beneficial to transmit RF noise to a ground outside of the magnetic resonance (MR) environment. Examples are provided below of filtering and shielding techniques, which will vary from implementation to implementation depending on the magnet style, that may be used in combination with the present camera systems when embodiments of the present camera systems are used for taking images during MRI scans.

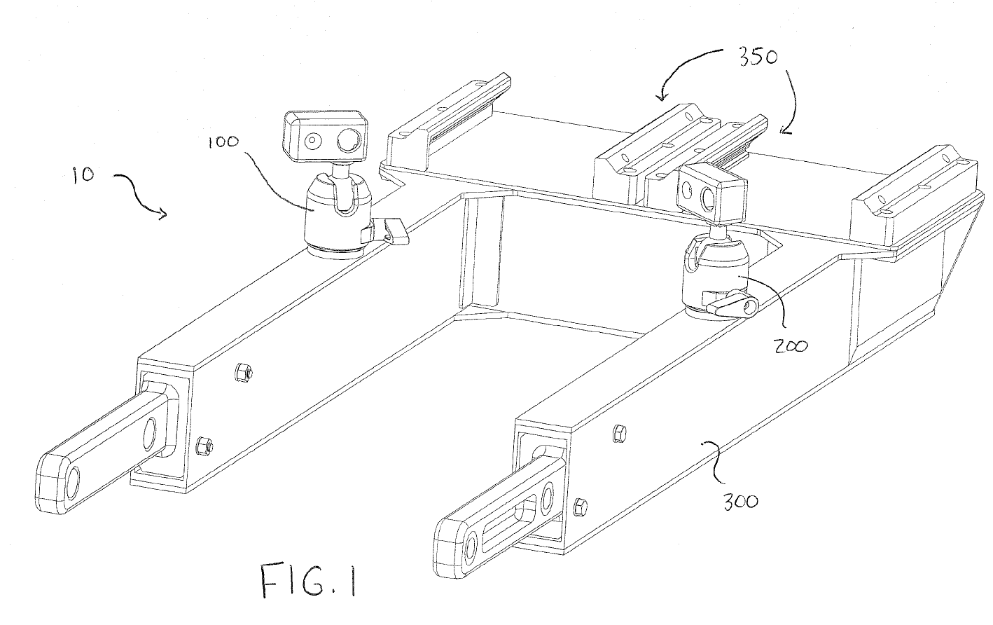

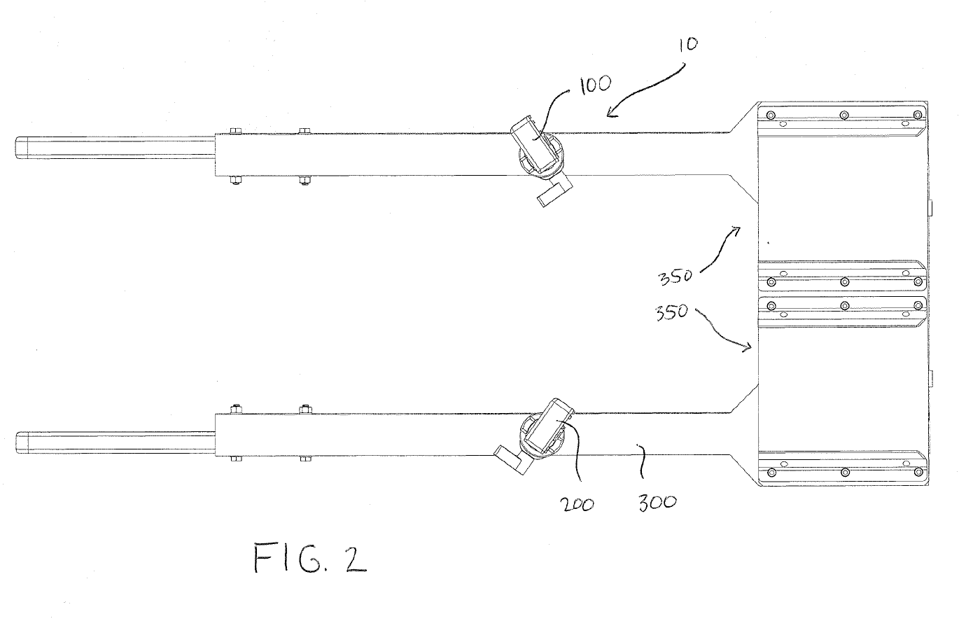

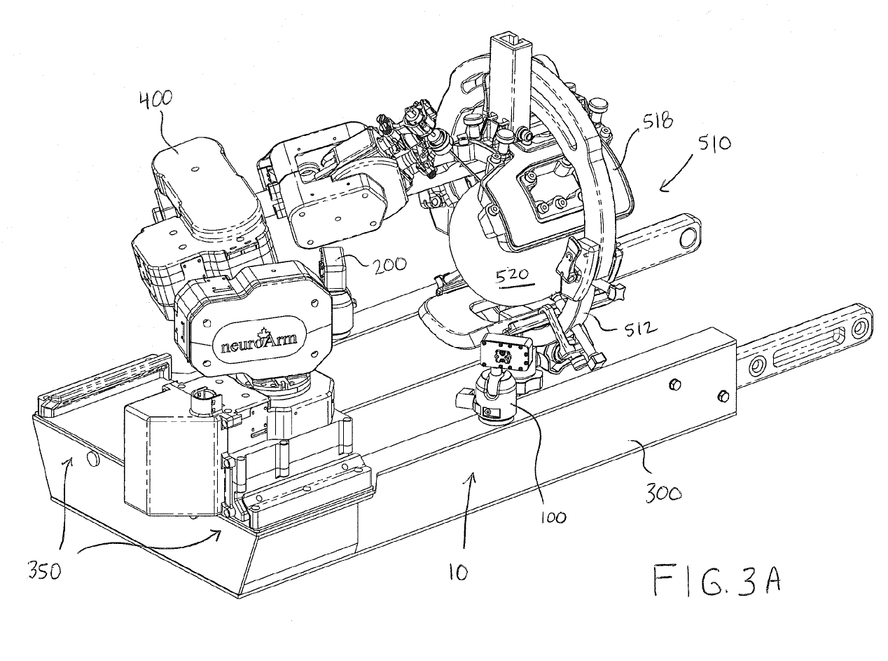

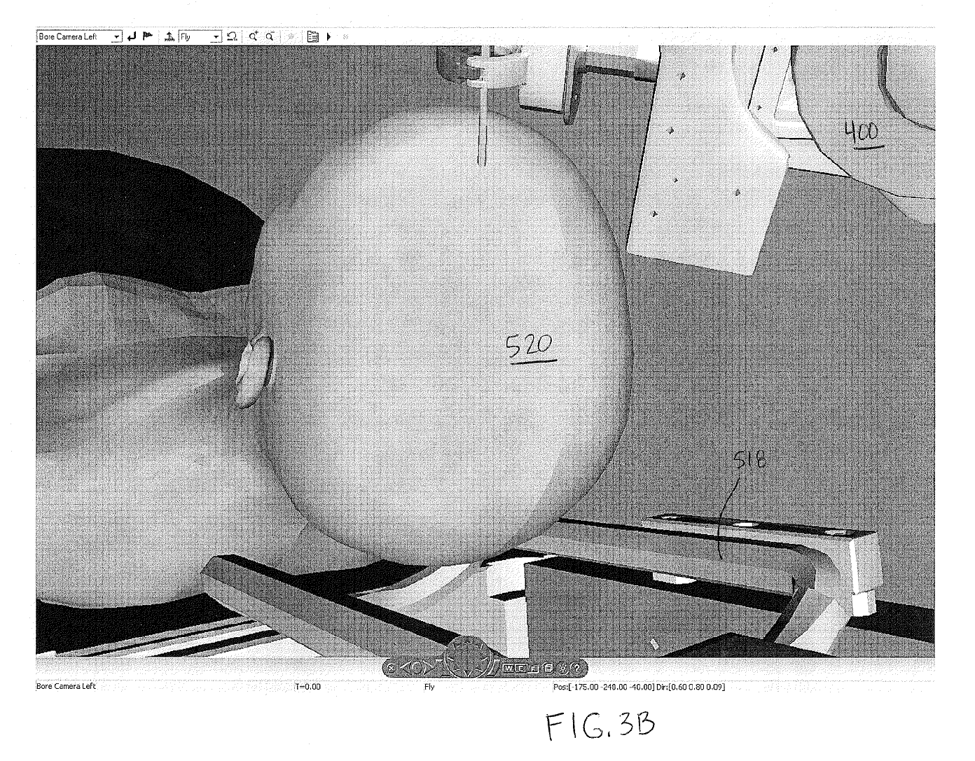

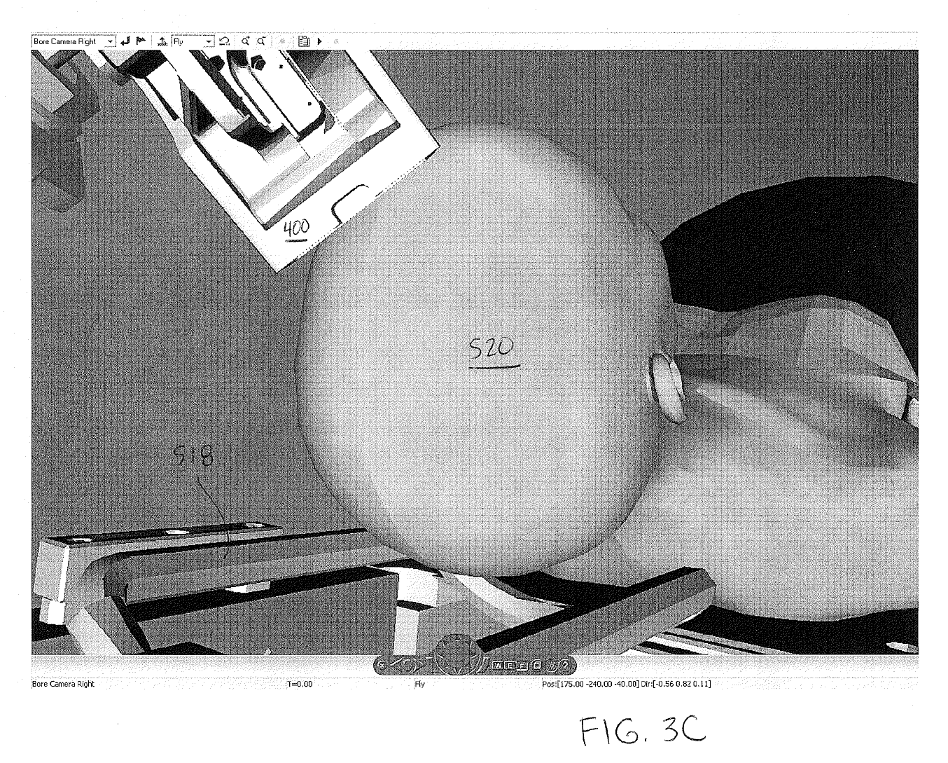

Referring initially to FIGS. 1 and 2, perspective and top views are shown of one of the present imaging systems: imaging system 10, which comprises a right camera system 100 and a left camera system 200, both of which are examples of the present camera systems and both of which are mounted on an extension board 300 (not part of the imaging system in some embodiments) that can be coupled to a patient support surface (not shown in FIGS. 1 and 2). (The present imaging systems may also be referred to as camera systems that include a first camera system and a second camera system.) Extension board 300 comprises a pair of docking stations 350 that each comprises a pair of mounting tracks for a robotic arm (also termed a (slave) manipulator). As shown in FIG. 3A, each docking station 350 can support a manipulator 400 (including, for example, the manipulators of the surgical robot disclosed in the '316 patent). FIG. 3A also shows a graphical representation of a subject's (e.g., a patient's) head 520 that is supported by an assembly 510 that includes a head clamp 512 to which a radio frequency (RF) coil device 518 is coupled, and shows that the left and right camera systems 200 and 100 may be positioned between manipulator 400 and the patient's head 520.

The camera systems can be oriented (as discussed in more detail below) such that the light source of each illuminates a different area of the operating space, and so that the camera of each captures an image of a different area of the operating space. However, the areas illuminated may overlap as may the subject matter captured in the image(s) obtained by each camera. FIG. 3B shows a graphical representation of an example of a view that can be obtained by left camera system 200 of an operating space (which can be characterized as a “left bore view”), and FIG. 3C shows a graphical representation of an example of a view that can be obtained by right camera system 100 of the operating space (which can be characterized as a “right bore view”). These figures illustrate the potential for overlapping illumination and image capture of the operating space of a surgical procedure. Graphical representations of an alternative version of manipulator 400, and an alternative version of a portion of RF device 518 are shown in FIGS. 3B and 3C.

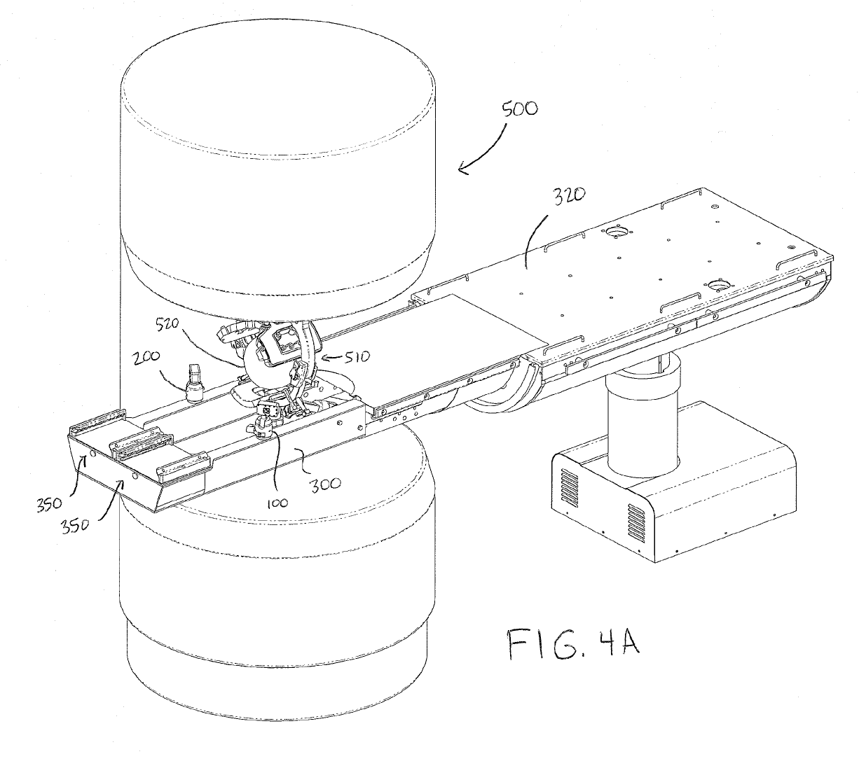

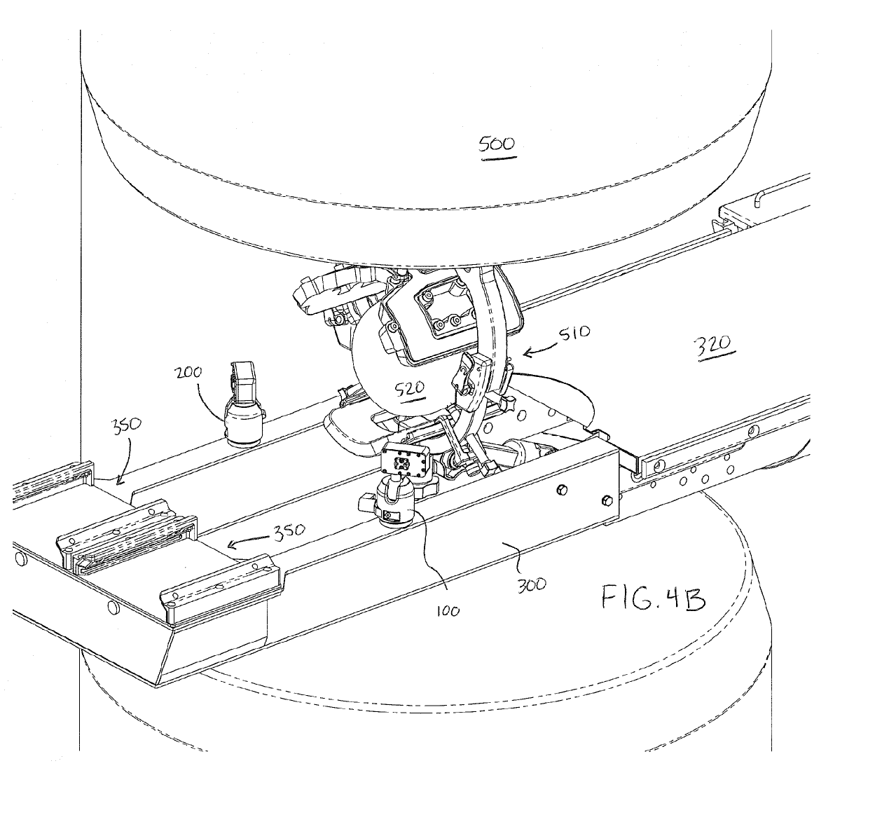

FIGS. 4A and 4B show that imaging system 10 may be used in an open bore MRI system 500. In the embodiment shown in these figures, extension board 300 is coupled to patient support surface 320, which is the top surface of an operating table. As shown, right and left camera systems 100 and 200 can be positioned such that they are bounded by (or within the vertically-oriented cylindrical perimeter defined by) the open bore magnet of system 500, and are directed toward head 520 of the subject to be operated on.

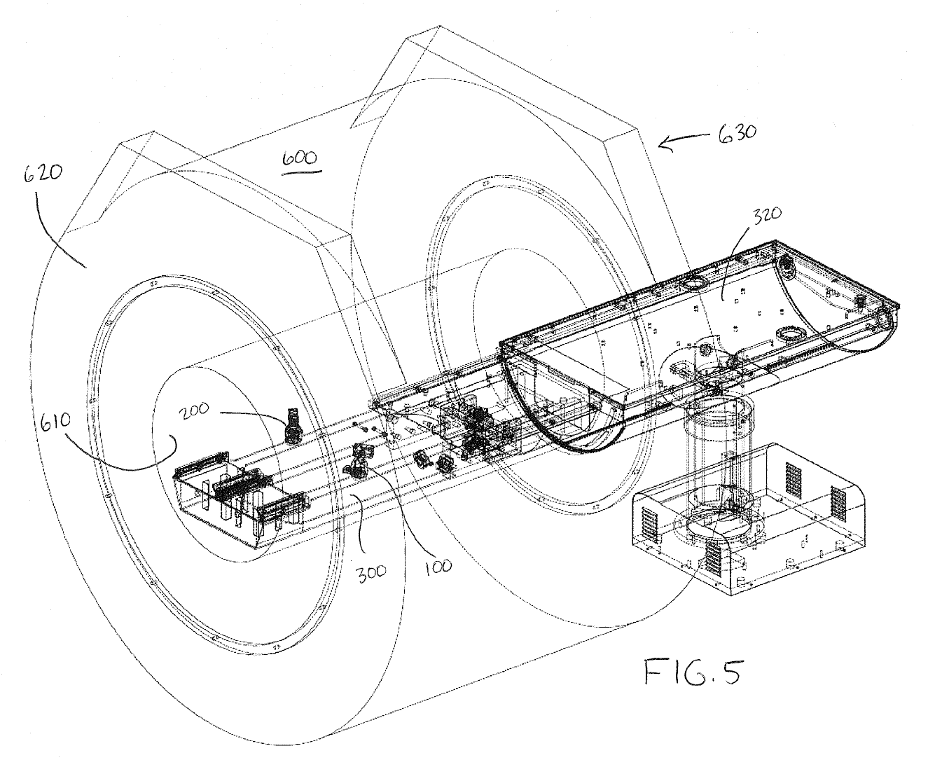

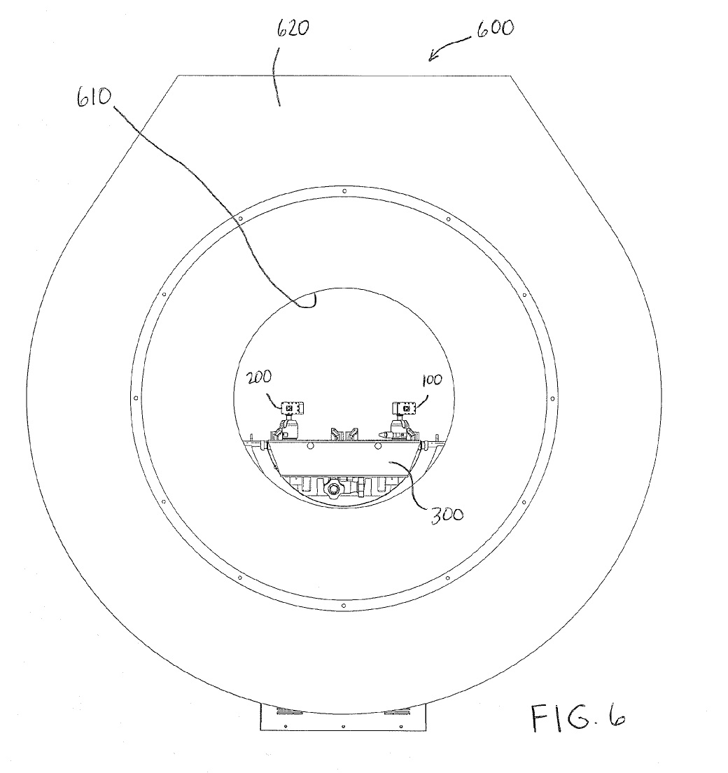

In FIG. 5, a perspective view of a closed bore MRI system 600 is shown in phantom so that the components placed within bore 610 of closed bore MRI system 600 are visible. System 600 may be a closed bore 1.5 Tesla MRI system. In this configuration extension board 300, as well as right and left camera systems 100 and 200, are shown within bore 610. Extension board 300 can be inserted into end 630 of bore 610 such that the docking stations are positioned proximate to end 620 of system 600. As shown, right and left camera systems 100 and 200 can be positioned such that they are bounded by (or within the laterally-oriented cylindrical perimeter defined by) the closed bore magnet of system 600, and can directed toward the head of a subject to be operated on. Referring now to FIG. 6, a view into bore 610 (as viewed from end 620) shows that right and left camera systems 100 and 200 are positioned to look toward a central region within bore 610.

As shown in FIGS. 4A-6, right and left camera systems 100 and 200 of imaging system 10 may be positioned to provide images of a subject area in either a closed bore or an open bore MRI configuration. In exemplary embodiments, camera systems 100 and 200 can be positioned such that, together, their collective field of view encompasses the usable working area of one or more manipulators used during a procedure involving the use of an MRI system.

In preferred embodiments, camera systems 100 and 200 are MR-compatible. This means, generally, that the camera system is MR-safe (being in the MRI system does not present a hazard to either the equipment or the subject); operation of the camera system is not adversely affected by operation of the MRI machine (and, more broadly, the MRI system of which the MRI machine is a part); operation of the MRI machine (and, more broadly, the MRI system of which the MRI machine is a part) is not adversely affected by operation of the camera system; and the MR image is not significantly affected by the presence of the camera system such that a maximum decrease in signal to noise ratio (SNR) of ten percent is permissible compared to when no camera system is present. In addition, the presence of one or both camera systems 100 and 200 should create minimal distortion of the images produced by the MRI system. SNR is calculated as: mean value of the signal divided by the standard deviation of the noise. Image distortion can happen when the local magnetic field is distorted by the presence of a magnetic or conductive material. Image distortion can take the form of signal dropout, such as where a viewer sees a black area, a lack of signal, or a geometrically distorted object.

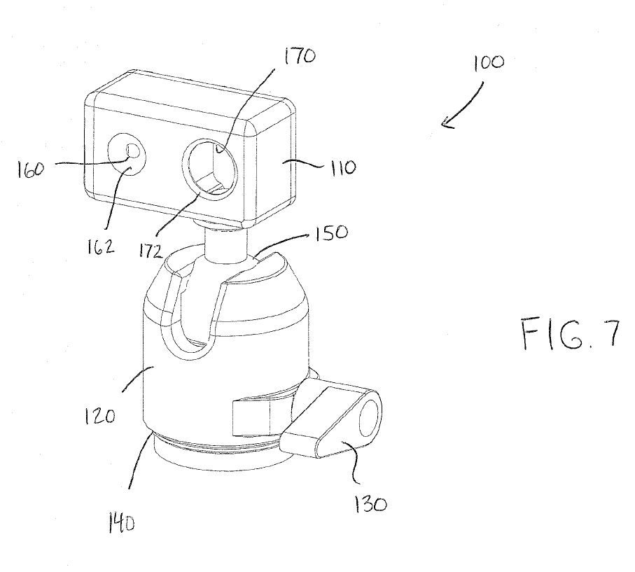

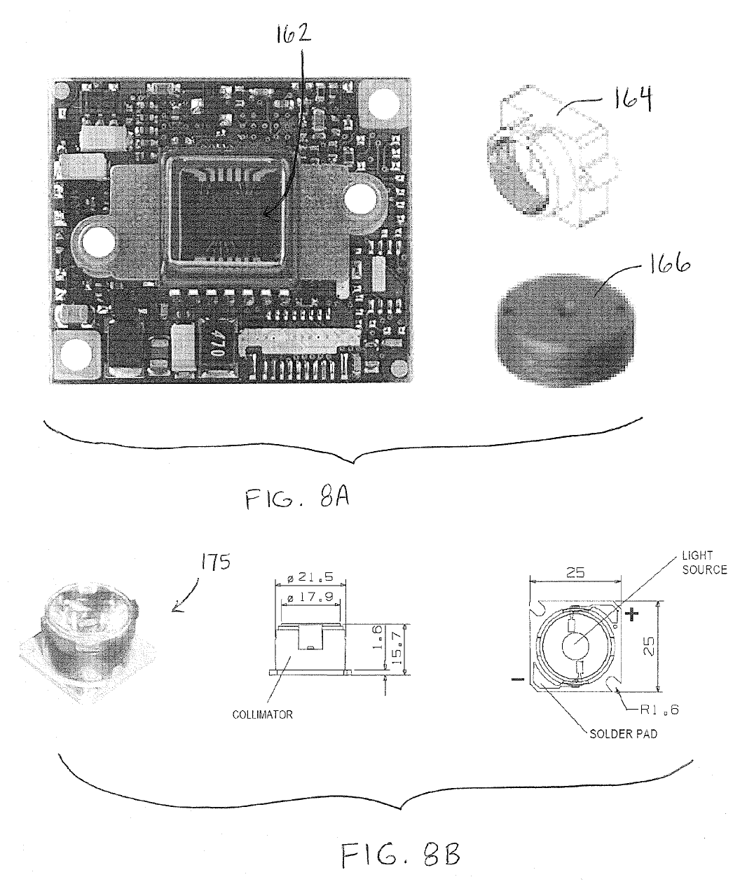

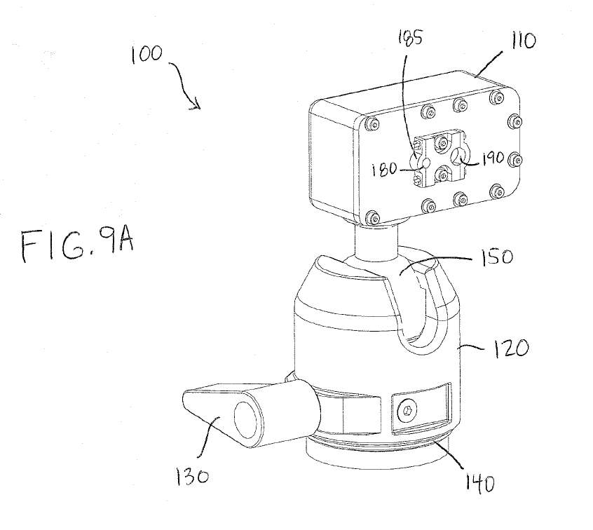

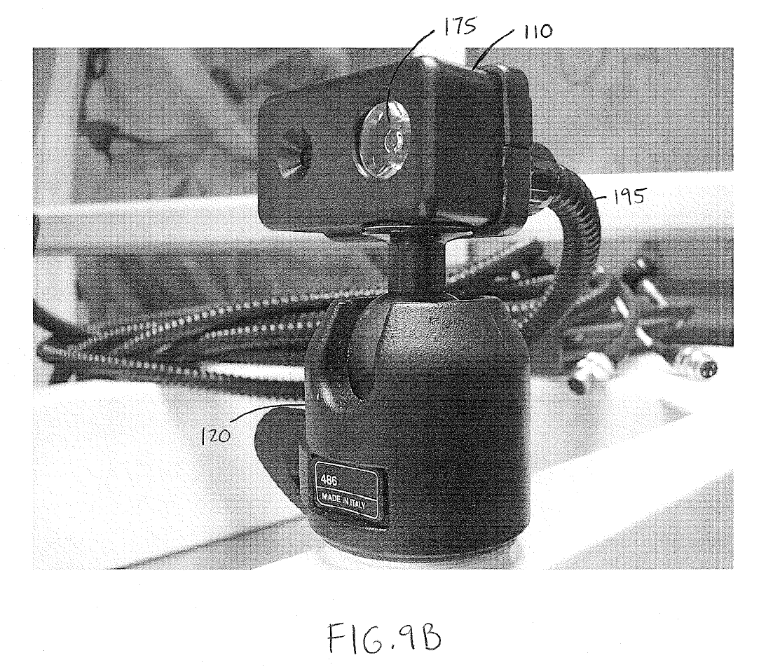

Referring now to FIGS. 7-9B, more detailed views are presented showing one embodiment of the present camera systems. Camera system 100 (note that the designations left and right in the foregoing description and figures do not signify functional or structural differences between the depicted camera systems; the two are substantially identical to each other in some embodiments, and identical in some embodiments) includes a head or upper portion 110 coupled to a body or base 120 via an adjustment mechanism 150 (for example, a swivel mount). Upper portion 110 comprises two openings, including a camera opening 160 and a light opening 170. FIG. 8A shows an example of a camera, which includes an actual camera 162 (attached to a board (unlabeled)), mount 164 to which the board on which camera 162 is attached may be mounted, and a pin-hole lens 166 (which fits inside of the mount and behind which the camera is positioned), that may be enclosed within upper portion 110 and oriented so that the lens is aligned with opening 160. FIG. 8B shows a light source generally designated as 175, that may include a collimator and a housing (both shown but unlabeled), that is contained within upper portion 110 and directed so that at least some light emitted from the light source passes through light opening 170. As shown in the back view of camera system 100 in FIG. 9A, upper portion 110 may also comprise an opening 180 for wiring to light source 175 and an opening 190 for wiring to the camera (e.g., the one shown in FIG. 8A) contained within upper portion 110. Such wiring may be contained within conduit 195 shown in FIG. 9B that houses the two cables (shown in the back of the figure) and is connected to connection adapter 185 of upper portion 110. FIG. 9B also shows light source 175 contained within upper portion 110 (as is a camera, though it is not visible at the depicted angle).

In specific embodiments, upper portion 110 may be a casing comprised of aluminum (or another suitable non-magnetic material) with separate cavities (or a single cavity that includes sufficient structural separations to prevent any radio frequency noise from the camera from entering the portion of the cavity occupied by the light source) for a camera and light source 175. In certain embodiments, upper portion 110 may act as a heat sink to help dissipate any heat generated by the camera and the light source. Camera opening 160 may be offset from the forwardmost surface of upper portion 110 via a tapered section 162 and may be smaller than light opening 170 (which also may be offset from the forwardmost surface of upper portion 110 via a tapered section 172, which is not as deep as tapered section 162), to reduce the amount of RF noise released by camera system 100 into the imaging environment. In certain embodiments, the DC power to light source 175 may be filtered, unlike the signal from the camera. The smaller camera opening 160 is, the more reduction can be achieved in the RF noise released to the imaging environment created by operation of the camera. The larger light opening 170 is, the more light can be provided to the subject area.

In specific embodiments, the camera shown in FIG. 7A may be a small (e.g., ¼ inch) charge-coupled device (CCD) color board camera that contains no critical magnetic or iron-core components (and minimal non-critical magnetic components, which can be replaced with non-magnetic components). The camera is therefore not attracted to a magnet, including those used in open and closed bore MRI systems. In still more specific embodiments, the camera may be one chosen from the Videology® 20K15X series of cameras (available from Videology Imaging Solutions, Inc., Greenville, R.I.), and may in particular be 20K152 with any compatible Flat M-12, Cone M-12, or Semi-Cone M-12 mount and pinhole lens combination (including the combination shown in FIG. 8A, the lens of which is part number 3355545N, which has a focal length of 5.5 millimeters and a minimum object distance of 50 centimeters).

In certain embodiments, light source 175 may be selected to provide adequate brightness in confined spaces, including closed bore MRI systems. In specific exemplary embodiments, light source 175 may be a white light-emitting diode (LED). In still more specific exemplary embodiments, light source 175 may be a Luxeon® LXHL-NWE8 light, which may be obtained from Phillips Lumileds Lighting Company (San Jose, Calif.) and is described on Lumileds Technical Datashect DS23. Utilizing a light source that requires only DC power will minimize RF interference (RFI) associated with using the light source, but it may be desirable to filter the DC power source to minimize the chance that the cable carrying the DC power acts as an antenna bringing in outside environmental noise into the imaging environment through light source opening 170.

In certain embodiments, opening 180 (for wiring to light source 175) receives wiring such as a 22 American wire gauge (AWG) shielded pair (e.g., Belden 83319, available from any authorized Belden Inc. distributor (a sales office for Belden is in Santa Fe Springs, Calif.)), transmitting direct current (DC) to light source 175. In specific embodiments, opening 190 (for wiring to camera 165) receives wiring such as 22 AWG hookup wire (e.g., Alpha 696-1362, available from any authorized Alpha Wire Company distributor (Alpha Wire Company has an office in Elizabeth, N.J.). In some embodiments, video signal from camera 165 may be transmitted over a 75 Ohm mini coax cable (e.g., Belden 8218), and the overbraid for the camera power and video may be tinned copper (e.g., Dearborn 92171 from Dearborn Wire and Cable, a Belden Company). Appropriate standard connectors can be configured for use in camera system 100 by replacing magnetic or iron-core components (for example, screws, clamps, or brackets) with non-magnetic components (such as brass equivalents that are off-the-shelf or hand-made, as necessary). Connectors that may be used with the present systems include those having original manufacturer part numbers: Amphenol T3504 001, and Amphenol T3300 001 (both are available from any authorized Amphenol distributor).

In certain embodiments, upper portion 110 comprises an aluminum enclosure that acts as an RF shield, so that any RFI coming from DC power to the camera, and from the camera itself, gets conducted along the enclosure, and back out along the cable to the system's shield. Upper portion 110 and the shielded cable coming from opening 190 can act as a bubble where RFI is allowed on the inside, but does not reach the imaging environment.

In the embodiment shown, base 120 comprises a coupler 140 (for example, a threaded portion) that allows camera system 100 to be coupled to extension board 300. In one specific embodiment, camera system 100 is coupled to extension board 300 approximately 40-75 centimeters (or any distance between) from the subject area being viewed (for example, a patient's head). A handle or controller 130 is coupled to base 120 and allows adjustment mechanism 150 to be placed in a locked or an unlocked position. In the locked position, adjustment mechanism 150 is restrained from moving so that upper portion 110 is fixed relative to base 120. In the unlocked position, adjustment mechanism 150 can be adjusted to that upper portion 110 is allowed to move relative to base 120. In the unlocked position, a user can adjust upper portion 110 so that camera system 100 is directed toward a desired field of view. When so positioned, light source 175 and the camera are both aimed at the desired subject area. After upper portion 110 is in the desired position, a user may place controller 130 in the locked position to retain upper portion 110 in place.

With camera systems 100 and 200 properly positioned, a user may conduct a procedure in which MRI imaging is performed while camera systems 100 and 200 transmit images of their respective portions of the subject viewing area. The images provided by camera systems 100 and 200 can provide useful information to the user that can assist in successfully performing and analyzing the procedure.

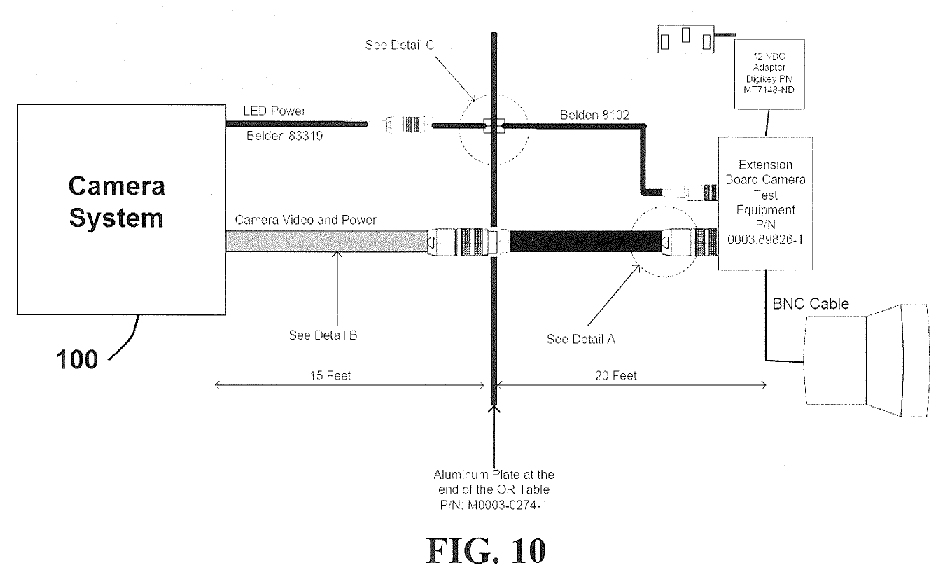

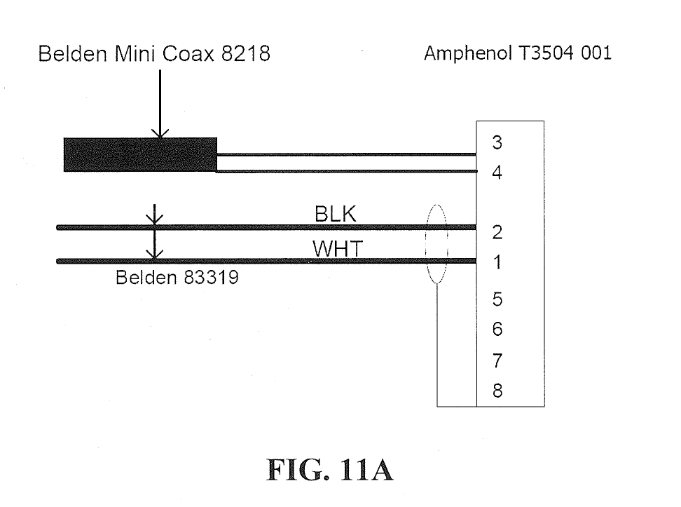

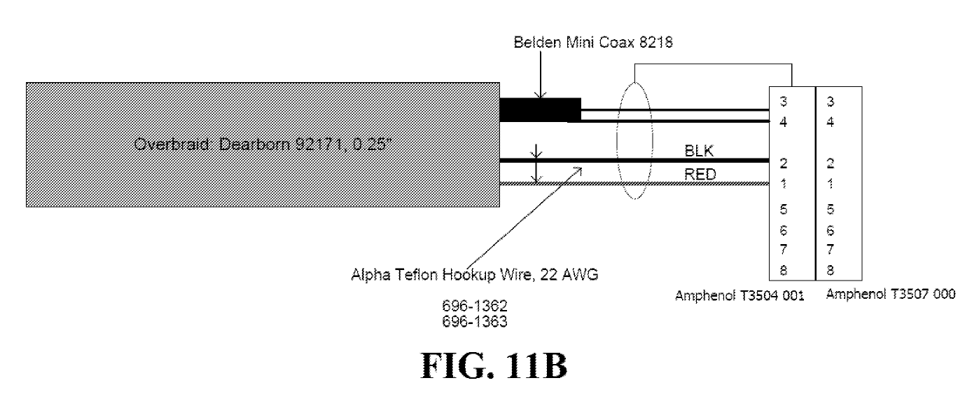

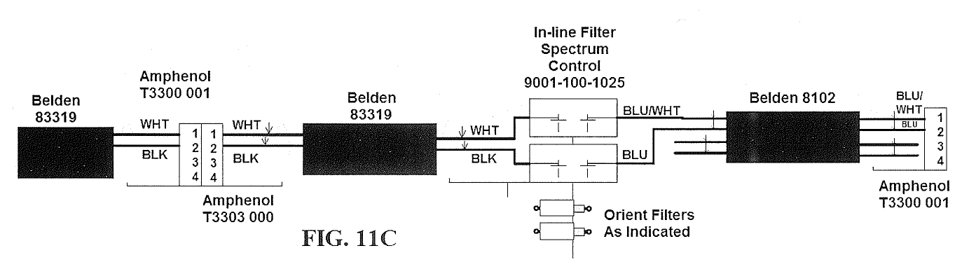

FIGS. 10 and 11A-11C illustrate a schematic view of an exemplary embodiment of a wiring system for camera system 100. FIG. 11A provides a detailed view of the section labeled “Detail A” in FIG. 10. In addition, FIGS. 11B and 11C provide detailed views of the sections labeled “Detail B” and “Detail C” in FIG. 10.

### Shielding Examples

Depending on the desired application for the present imaging systems (which may include one or more of the present camera systems), local shielding or room shielding may be appropriate. For example, using a closed bore 1.5 Tesla (“1.5 T”) MRI system may involve local shielding while using a closed bore 3.0 Tesla (“3 T”) MRI system may involve room shielding. A locally shielded magnet may rely on the imaging environment being sealed from RFI through the use of a Faraday cage. For a closed bore magnet, the head-end of the bore may be sealed using a copper-mesh impregnated PLEXIGLAS disk that is attached to the magnet face and shield. The foot end of the bore may be sealed using a Faraday cage that goes over the patient's legs (and sits on the operating room bed) and attaches to the magnet using a silver impregnated mesh. The cage itself may be made of copper wire impregnated PLEXIGLAS. This “dog house” may create an RFI-free environment all around the patient's body, and also help keep powerful RF impulses from being thrown out into the hospital environment. A penetration panel with specialized filters may be used to get cables into and out of the imaging environment without introducing RFI. If the penetration panel is not mounted directly on the Faraday cage, any cables going into the cage should be shielded, and should carry RFI along the cable out of the environment and out to the shield. Embodiments of the present camera systems may be shielded by shielding the housing (as described above) and shield any cables coming into/out of the housing (as described above) such that any RFI gets transmitted to the penetration panel located outside of the imaging environment.

In a room-shielded environment, copper sheets in the walls/floor/ceiling of the operating room create a shielded “box” around the operating room (OR), and the only cables coming into or out of the box do so through penetration panels or wave guides. Penetration panels are specialized filters that filter noise off of cables that act as antennae for RFI (typical copper cables). For cables that do not pick up and carry noise (such as fiber optic cables, plastic air tubes, etc.) wave guides are used. Wave guides are cylindrical penetrations in the wall of the operating room, and provide a minimum length/diameter ratio such that RF waves will not make it through them. With the present camera systems, if the cables for both the light source and the camera are copper, a penetration panel can be used. As in a locally shielded environment, the camera and cable that are inside the MRI environment—here, the whole OR—should create a bubble of RFI that is contained within their shielding, and which sends the RFI back to the penetration panel and room shield.

MR-compatible embodiments of the present camera systems may be configured so as to be useable with either or both local and room shielded magnets that are either the open or closed bore type.

Descriptions of well known techniques, components and equipment have been omitted so as not to unnecessarily obscure the present camera systems and illumination methods in unnecessary detail. The descriptions of the present methods, devices and systems are exemplary and non-limiting. Certain substitutions, modifications, additions and/or rearrangements falling within the scope of the claims, but not explicitly listed in this disclosure, may become apparent to those of ordinary skill in the art based on this disclosure. Furthermore, it will be appreciated that in the development of a working embodiment, numerous implementation-specific decisions must be made to achieve the developers' specific goals, such as compliance with system-related and business-related constraints, which will vary from one implementation to another. While such a development effort might be complex and time-consuming, it would nonetheless be a routine undertaking for those of ordinary skill in the art having the benefit of this disclosure.

The appended claims are not to be interpreted as including means-plus-function limitations, unless such a limitation is explicitly recited in a given claim using the phrase(s) “means for” and/or “step for,” respectively.

1. A camera system comprising:
a first magnetic resonance (MR) compatible casing having at least two separate openings;
a first camera oriented to view a site through one of the separate openings; and
a first light emitting diode (LED) light source oriented to illuminate at least a portion of the site through another of the separate openings.

2. The camera system of claim 1, further comprising:
a second MR-compatible casing having at least two separate openings;
a second camera oriented to view a second site through one of the separate openings of the second casing; and
a second light emitting diode light source oriented to illuminate at least a portion of the second site through another of the separate openings of the second casing.

3. The camera system of claim 1, further comprising:
a first shielded cable that delivers power to the first LED light source; and
first shielded video and power cables coupled to the first camera.

4. The camera system of claim 2, further comprising:
a first shielded cable that delivers power to the first LED light source;
first shielded video and power cables coupled to the first camera;
a second shielded cable that delivers power to the second LED light source; and
second shielded video and power cables coupled to the second camera.

5. (canceled)

6. The camera system of claim 1, where the camera system includes a first upper portion that includes the first camera and the first LED light source, and a first base to which the first upper portion is swivel-mounted.

7. The camera system of claim 6, where the orientation of the first upper portion can be adjusted manually after unlocking a controller coupled to the first base.

8. The camera system of claim 2, where the camera system includes a second upper portion that includes the second camera and the second LED light source, and a second base to which the second upper portion is swivel-mounted.

9. The camera system of claim 8, where the orientation of the second upper portion can be adjusted manually after unlocking a controller coupled to the second base.

10. The camera system of claim 2 for use with a manipulator configured to be secured to an extension member that can be coupled to an operating table on which a patient can be positioned for a stereotactic procedure, the manipulator being operable to move a surgical instrument located within the bore of an MRI magnet, where
the first and second camera systems are each configured to be coupled to the extension member.

11.-13. (canceled)

14. The camera system of claim 10, where the first camera system includes an upper portion that includes the first camera and first LED light source, and a base to which the upper portion is swivel-mounted.

15. The camera system of claim 14, where the orientation of the upper portion can be adjusted manually after unlocking a controller coupled to the base.

16.-17. (canceled)

18. The camera system of claim 10, where the second camera system includes an upper portion that includes the second camera and second LED light source, and a base to which the upper portion is swivel-mounted.

19. The camera system of claim 18, where the orientation of the upper portion can be adjusted manually after unlocking a controller coupled to the base.

20.-21. (canceled)

22. A method comprising:
illuminating a first portion of a patient positioned at least partially within a bore of a magnet of a magnetic resonance imaging (MRI) system with a first light emitting diode (LED) light source coupled to a first camera positioned within the bore, the illuminating occurring during a surgical procedure on the patient.

23. The method of claim 22, further comprising:
supplying power to both the first LED light source and the first camera while the MRI system is taking magnetic resonance (MR) images of the patient.

24.-25. (canceled)

26. The method of claim 22, further comprising:
illuminating a second portion of the patient with a second LED light source coupled to a second camera positioned within the bore;
where the illuminating of both the first and second portions occurs at the same time and during the surgical procedure on the patient.

27. The method of claim 26, where the first and second portions overlap to at least some extent.

28. The method of claim 26, further comprising:
supplying power to both the first and second LED light sources and the first and second cameras while the MRI system is taking magnetic resonance (MR) images of the patient.

29. The method of claim 22, where the MRI system is an open bore MRI system.

30. The method of claim 22, where the MRI system is a closed bore MRI system.

31.-34. (canceled)

35. A method comprising:
positioning a first light emitting diode (LED) light source coupled to a first camera in a bore of a magnet of a magnetic resonance imaging (MRI) system; and
supplying power to both the first LED light source and the first camera and receiving images from the first camera while the MRI system images an object.

36. The method of claim 35, where the MRI system is an open bore MRI system.

37. The method of claim 35, where the MRI system is a closed bore MRI system.

38. The method of claim 35, further comprising:
positioning a second LED light source coupled to a second camera in the bore;
supplying power to both the second LED light source and the second camera and receiving images from the second camera while the MRI system images an object,
and orienting the first and second cameras at a distance from each other and from a site to be imaged such that the images the cameras capture can be displayed to a user as a three-dimensional stereoscopic image of the site.

39. The camera system of claim 10, further comprising:
a first shielded cable that delivers power to the first LED light source;
first shielded video and power cables coupled to the first camera;
a second shielded cable that delivers power to the second LED light source; and
second shielded video and power cables coupled to the second camera.
